(19) United States
(12) Patent Application Publication
(10) Pub. No.: US 2010/0057497 A1
(43) Pub. Date: Mar. 4, 2010

(54) DYNAMIC SPONSORED RESEARCH DEVELOPMENT

(75) Inventors: Forrest Lee Chamberlain, South Burlington, VT (US); Jessica Bolduc, South Burlington, VT (US); Sriam Peri, South Burlington, VT (US); Christopher Brown, North Ferrisburg, VT (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 12/201,191

(22) Filed: Aug. 29, 2008

(51) Int. Cl. G06F 19/00

(52) U.S. Cl. 705/3

(57) ABSTRACT

Certain embodiments of the present invention provide a system for dynamically displaying clinical information to a user, the system including: a table for displaying the clinical information, the table including entries; an information display subsystem for displaying the clinical information in the table; and an information collection subsystem for collecting a first portion of the clinical information at a first time, for collecting a second portion of the clinical information at a second time, and for providing the first and second portions to the information display subsystem, wherein the information display subsystem displays the first portion of the clinical information at a first display time in the table, and integrates the first and second portions of the clinical information to form an integrated data set, and displays the integrated data set in the table at a second display time such that each of at least a portion of the entries includes information from both of the first and second portions of the clinical information. In an embodiment, the user is capable of interacting with an entry at substantially the first display time.

### BACKGROUND OF THE INVENTION

Embodiments of the present application relate generally to dynamic display of clinical information through a user interface. Particularly, certain embodiments relate to dynamic updating of tabular data and intelligent processing.

When reviewing a patient's medical history, a reviewing clinician is faced with managing a potentially large amount of information. It should be understood that a patient's medical history may also include presently generated studies or exams that are in a condition for clinical review. For a given patient, there may be studies or exams spanning over a period of months or years. The studies or exams may cover a variety of conditions and/or body parts. The studies or exams may pertain to various clinical areas—e.g., radiology, cardiology, laboratory exams, neurology, pathology, oncology, etc. For radiology and other medical imaging applications, the studies may be generated through various modalities—e.g., CT scan, fluoroscopy, tomography, ultrasound, MRI, etc.

Furthermore, there may be layers of information for each study or exam—e.g., various levels of information such as metadata, high-level study information, and underlying study data. The underlying data may also be stored in a variety of forms—e.g., linked database information, images, movies, text, etc. In addition, a patient's information may contain numerous other data types, such as name, age, health insurance, family history, allergies, etc. Given the potentially vast and diverse amount of information for any given patient, a reviewing clinician is faced with a difficult task.

Viewing applications often display data to users in tabular format. When there is a large volume of data, or when generating the data involves extensive computation, waiting for all of the data to be available may be inconvenient for a user. Some users may prefer to see partial results first. One solution is “paging”—showing the user a first set results (e.g., a “page”), and allowing the user to request subsequent sets of results as desired. Thus, there is a need for efficiently displaying clinical information to a user.

### BRIEF SUMMARY OF THE INVENTION

Certain embodiments of the present invention provide a system for dynamically displaying clinical information to a user, the system including: a table for displaying the clinical information, the table including entries; an information display subsystem for displaying the clinical information in the table; and an information collection subsystem for collecting a first portion of the clinical information at a first time, for collecting a second portion of the clinical information at a second time, and for providing the first and second portions to the information display subsystem, wherein the information display subsystem displays the first portion of the clinical information at a first display time in the table, and integrates the first and second portions of the clinical information to form an integrated data set, and displays the integrated data set in the table at a second display time such that each of at least a portion of the entries includes information from both of the first and second portions of the clinical information. In an embodiment, the first and second portions of the clinical information are determined by at least one of: a domain specific set of rules, and a user specific set of rules. In an embodiment, the information collection subsystem pipelines the information portions to the information display subsystem. In an embodiment, the user is capable of interacting with an entry at substantially the first display time. In an embodiment, the system further includes an intelligent learning subsystem for adjusting the dynamic display of clinical information to the user in the table. In an embodiment, the first portion of the clinical information results from a query to a relational database, and the second portion of the clinical information results from a sub-query to the relational database. In an embodiment, the second portion of the clinical information results from calculations performed on at least a portion of the first portion of the clinical information.

Certain embodiments of the present invention provide a method for dynamically displaying clinical information to a user, the method including: receiving at a first collection time a first portion of the clinical information; displaying at a first display time the first portion of the clinical information in a table including entries; receiving at a second collection time a second portion of the clinical information; integrating the first and second portions of the clinical information to form an integrated data set for display in the entries, such that at least a portion of the entries includes information from both the first and second portions of clinical information; and displaying at a second display time the integrated data set. In an embodiment, the first and second portions of the clinical information are determined by at least one of: a domain specific set of rules, and a user specific set of rules. In an embodiment, the method further includes pipelining the first and second portions of clinical information for display. In an embodiment, the user is capable of interacting with an entry at substantially the first display time. In an embodiment, the method further includes intelligently learning interactions of a user to adjust the dynamic display of clinical information to the user in the table. In an embodiment, the first portion of the clinical information results from a query to a relational database, and the second portion of the clinical information results from a sub-query to the relational database. In an embodiment, the second portion of the clinical information results from calculations performed on at least a portion of the first portion of the clinical information.

Certain embodiments of the present invention provide a computer readable storage medium including a set of instructions for a computer, the set of instructions including: a reception routine for receiving at a first collection time a first portion of clinical information, and for receiving at a second collection time a second portion of the clinical information; an integration routine for integrating the first and second portions of clinical information to form an integrated data set for display in a table having entries, such that at least a portion of the entries includes information from both of the first and second portions of clinical information; and a display routine for displaying at a first display time the first portion of clinical information in the table, and for displaying a second display time the integrated data set in the table. In an embodiment, the first and second portions of the clinical information are determined by at least one of: a domain specific set of rules, and a user specific set of rules. In an embodiment, at least a portion of the entries includes information from the first portion of the clinical information only. In an embodiment, the set of instructions further includes a learning routine for intelligently learning a users interactions with the table to subsequently adjust a dynamic display of clinical information. In an embodiment, the first portion of the clinical information results from a query to a relational database, and the second portion of the clinical information results from a sub-query to the relational database. In an embodiment, the second portion of the clinical information results from calculations performed on at least a portion of the first portion of the clinical information.

### BRIEF DESCRIPTION OF SEVERAL VIEWS OF THE DRAWINGS

FIG. 1 shows a block diagram of a system for managing clinical information, in accordance with an embodiment of the present invention.

FIG. 2 shows a table for displaying clinical information, in accordance with an embodiment of the present invention.

FIG. 3 shows a flow chart for a method of managing clinical information, in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

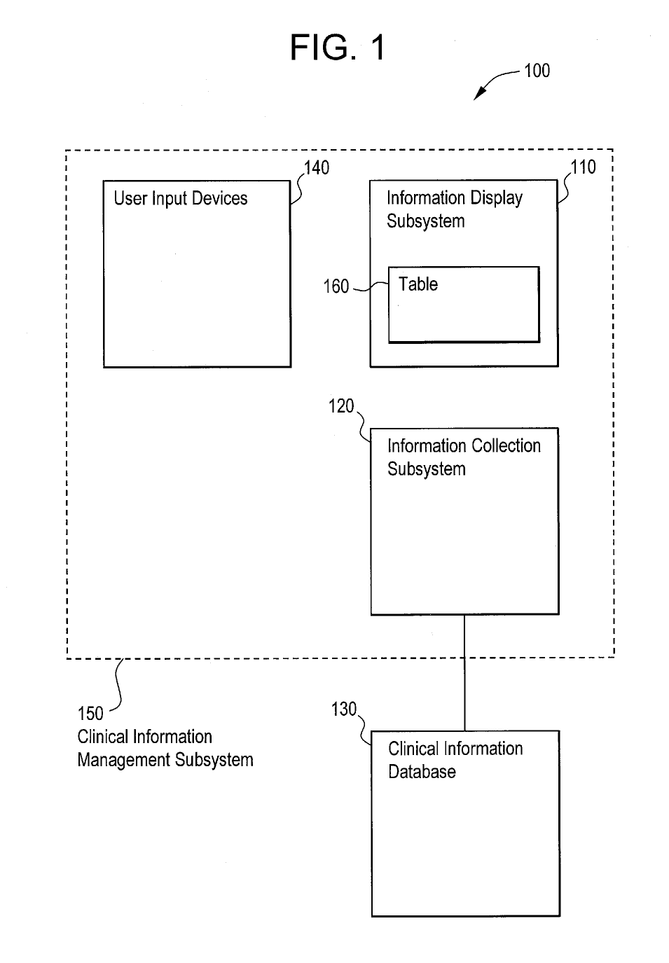

FIG. 1 shows a block diagram 100 of a system for managing clinical information, in accordance with an embodiment of the present invention. The system 100 may include a clinical information database 130, a clinical information management subsystem (“ICS”) 150, an information display subsystem (“IDS”) 110, a table 160, user input device(s) 140, and an information collection subsystem. The system 100 may be incorporated into an enterprise system, such as a radiological information system (“RIS”), or picture archiving and communication system (“PACS”).

The clinical information database 130 may include information pertaining to patients. The database 130 may be a SQL, DICOM image, electronic medical record (EMR), file system, and/or external system type database, for example. The database 130 may be located on one or more servers. The database 130 may include information from a plurality of sub-databases. For example, the database 130 may be a logical and/or physical grouping of several sub-databases. A logical grouping of sub-databases may occur in the database 130 itself, or in other parts of system 100, such as information collection subsystem 120. The database 130 may include various types of information for a given patient, such as, for example, the patient's name, age, emergency contact information, allergies, physical characteristics, insurance information, medical history, past exams and studies, and/or present exams and studies. The database 130 may be a relational database.

The clinical information management subsystem 150 may be an information management system, such as a PACS system. The clinical information management subsystem 150 may include an information display subsystem 110, an information collection subsystem 120, and user input device(s) 140. Through the user input device(s) 140, a user, such as a radiologist, may be able to interact with the subsystem 150 to view and manipulate patient information.

The information display subsystem 110 may be capable of displaying patient information through a table 160. The IDS 110 may include a display, and/or may be a driver engine for a display. The IDS 110 may receive information through an ICS 120, and dynamically display the information in the table 160. In turn, the ICS 120 may collect information from the clinical information database 130.

The IDS 110 and ICS 120 may be implemented through one or more processors and associated hardware in the clinical information management subsystem 150. The IDS 110 and ICS 120 may be logically and/or physically separate or integrated. The IDS 110 and/or ICS 120 may include processes, applications, routines, or the like that run on processor(s) in the clinical information management subsystem 150. The IDS 110 and/or ICS 120 may be performable through hardware systems.

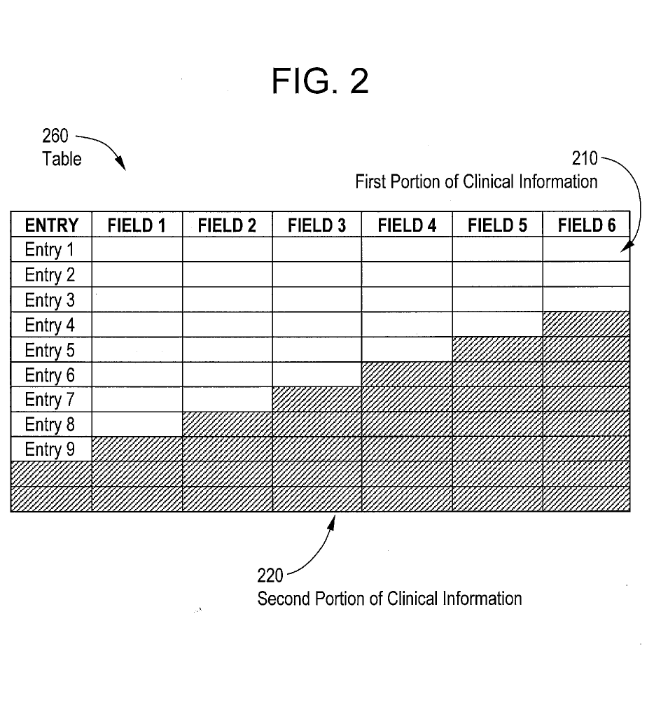

FIG. 2 shows a table 260 for displaying clinical information, in accordance with an embodiment of the present invention. The table 260 may be similar to the table 160. The table may be displayed in various forms. The table 260 contains a plurality of entries. The entries have a plurality of associated data fields for displaying various data associated with an entry. As shown, the table 260 may be displayed in a grid view format. Other formats are also possible, such as a text list, a mixed text and iconic list, a banded grid view, a hierarchical view, an expandable view, and/or the like.

As an example, a series of entries may correspond to a worklist for a radiologist, and may correspond to the radiologist's review tasks. For example, the entries may represent a list of patients who have exams for review, or who have exams to be scheduled. For example, the associated data fields for each entry may correspond to certain patient information, such as patient name, age, sex, present study, present study modality, exam location, diagnosis codes, body part of imaging, treating physician, patient condition, prior stud(ies), prior medical history, and/or the like. The entries and fields may be dynamically populated through the IDS from information gathered by the ICS.

Information in the table 260 may include a first portion of clinical information 210 and a second portion of clinical information 220. Additional portions may also be included. The table 260 may dynamically display the portions by displaying the first portion 210 at a first display time, and an integrated view of the first and second portions 210, 220 at a second display time. The table 260 may support paging and/or scrolling. The boundary between the first portion 210 and the second portion 220 may be determined by a set of rules Such a set of rules may be determined by a domain-specific context.

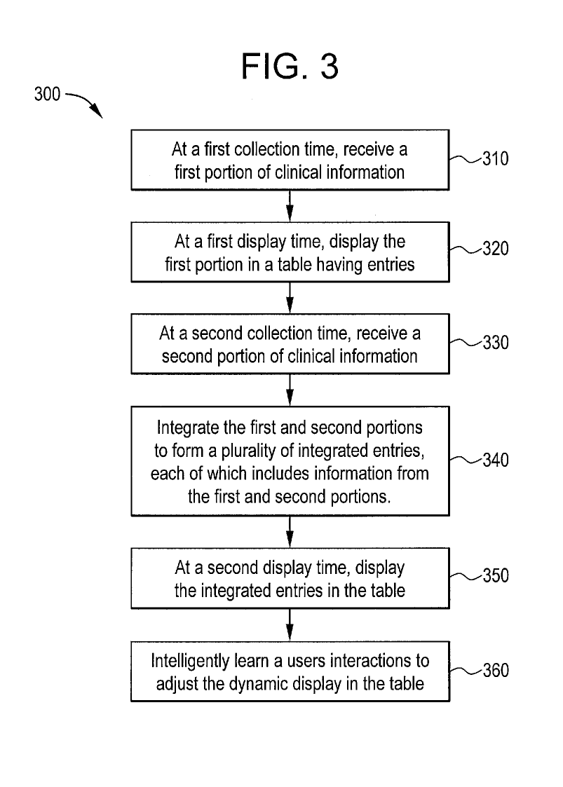

FIG. 3 shows a flow chart 300 for a method of displaying clinical information, in accordance with an embodiment of the present invention. The steps of the flow chart 300 may be performable, for example, by a system, such as system 100 and a table, such as those shown in FIGS. 1 and 2. Furthermore, the steps of method 300 may be performable in a different order, or some steps may be omitted according to design and/or clinical preferences. For example, step 330 may be performed before step 320. Method 300, or a portion thereof, may be performable by one or more processing units. Method 300, or a portion thereof, may be performable by software, hardware, and/or firmware. Method 300, or a portion thereof, may also be expressible through a set of instructions stored on one of more computer-readable storage media, such as RAM, ROM, EPROM, EEPROM, optical disk, magnetic disk, magnetic tape, and/or the like.

At step 310 the ICS collects a first portion of clinical information at a first collection time. The ICS may collect the first portion of information at the directive of the IDS, or may collect it based on internal decisions. The first portion of information may correspond to data to be displayed to the user first. Such information may allow the user to view and interact with the table before it is completely populated. The first portion of information may be gathered from a database, such as database 130. As an example, the first portion of information may result from a query to a relational database. The scope and content of the first portion of information may be determined by a variety of factors, such as a user preference or set of rules, intelligent learning of a user's interactions, and a set of rules associated with a particular clinical context.

For example, a radiology unit may have a certain set of rules that determines which entries and associated fields should be initially populated. Rules may specify which entries, or exams, to populate first. For example, “stat” exams may be populated first. Similarly, certain exam types that are higher priority to the organization may be populated first. There may be compound rules (e.g., show stat exams of a certain exam type first), and multi-level rules (e.g., show stat MR exams first, then stat CT exams, then any other stat exams, then non-stat MR exams, etc.). Such compound rules may operate according to Boolean functions and/or algorithms.

There may also be rules about how and when associated fields should be populated. Such rules may also be compound or multi-level rules. The following is an example of field-type rules: (1) collect and display patient name, patient identifier (e.g. MRN), exam type, and exam identifier (e.g., accession #); (2) collect and display other demographic information (patient date of birth, age, gender, etc.); (3) collect and display other exam information (e.g., performing resource, exam subspecialty, who performed the exam, etc.); (4) collect and display image status; and (5) collect and display information about related exams the patient has had in the past.

Entry and field type rules may be combined, so that different sets of information may collected and displayed initially for exams assigned different priorities. For example, a combined entry and field set of rules is illustrated as follows: (1) initially collect all possible information for stat MR exams but only patient demographics for all other stat exams, and display no information for non-stat exams; (2) collect all remaining information for remaining stat exams, and display patient demographics for all other exams; (3) collect and display other exam information for the remaining exams; (4) incrementally collect and display image status for each remaining exam; (5) incrementally collect and display related exam information for each remaining exam. Such rules may provide efficiency for a user's review of the entries in the table.

With respect to steps 310 and 330, the information may be collected using various techniques or a combination of techniques. For example, the ICS may send two different queries to a database at two different times. The results from each of the queries may correspond to the first and second portions of information. Such a technique may help reduce network or server side latencies. As another example, the ICS may receive a single portion of data, and may pipeline it into separate portions. The pipelined information may be communicated to the IDS. In such a way, pipelining may also be useful for filtering, formatting, and/or arranging information in an efficient way for display.

At step 320, the first portion of information may be displayed in the table at a first display time. The IDS may receive the first portion of information from the ICS, and may populate a subset of the table at the first time. For example, as shown in FIG. 2, some or all of the entries may be fully or partially populated with the first portion of information. For example, the entries may be populated with the patient's name and the type and modality for the study to be reviewed, and other fields may not be populated. As another example, only some of the entries may appear in the first portion of information. In such a case, entries may be selected for inclusion in the first portion of information based on the value of a particular field, such as modality of imaging. For the non-populated entries and/or fields, the display may include placeholders. The user may be able to interact with the first portion of data to scroll through the entries and/or fields of the table. The user may also be able to interact with the first portion of data by paging through the entries and/or fields of the table.

The user may be able to interact with the first portion of the information displayed in the table by the IDS. For example, a user may be able to select entries, studies, and/or exams that have been populated. The entries and fields may only display a subset of information contained in the first portion of information. When interacting with the entries and/or fields, the user may be able to further view some of the first portion of information that was not immediately displayed in the table. For example, a user may be able to bring up images relating to a study where the images were not immediately displayed in the table. The user may be able to interact with some of the entries and/or fields, where such interaction influences which additional information will be included in the second portion of information.

Calculations and algorithms may be applied to data in the first portion to influence the information contained in the second portion. Such calculations and algorithms may be performed automatically by the IDS or ICS. Optionally, such calculations and algorithms may result from a user interaction. As a further example, information in the first portion may result from a query to a relational database. Based on the information, the IDS or ICS may determine what subqueries should be performed to obtain the second portion of information. The determination of subqueries may occur automatically, or may result from a user interaction.

At step 330, a second portion of information may be collected at a second collection time. Information may be collected as described in step 310. The nature of the second portion of information may be determined as described in step 320. The second collection time may occur before or after the first display time. The determination of what information will be collected in the second portion may occur at steps 310, 320, and/or 330. The flow chart may repeat, looping back to steps 310 or 330, for example, to collect additional portions of clinical information. Any number of information collections, or phases, may be performed. It may be possible, for example, to have a near-continuous sequence of collection phases, and a corresponding near-continuous display of the information.

At step 340, the first, second, and or subsequent portions may be integrated into an integrated data set. Such integration may be performed by the IDS or the ICS, for example. The integration may be additive and/or cumulative. The integration may result in replacement and/or enhancement of certain entries and/or fields from the first portion of information. The flow chart may repeat, looping back to steps 310 or 330, for example, to collect additional portions of clinical information.

At step 350, the integrated entries may be displayed in the table at a second display time. The integrated entries may be displayed much like the display of information described in step 320. The flow chart may repeat, looping back to steps 310 or 330, for example, to collect additional portions of clinical information.

At step 360 the system may intelligently learn a user's interactions and/or preferences to adjust the dynamic display of information in the table. For example, the system(s) (e.g., the ICS or IDS) may observe which items the user tends to act on first in various scenarios, and alter a prioritization algorithm accordingly. For example, the system may notice that a radiologist user tends to have MR exams performed at his home location early in the morning. In such a situation, the algorithm or rules may be adapted to collect more information about those particular exams than other exams in the initial phase(s) when the radiologist brings up his exams-based worklist between 8 am and 10 am.

To illustrate an example, the flow chart 300 may be implemented in the following manner. This illustration corresponds to the examples discussed above in context with steps 310 and 330. At step 310, the ICS receives the first portion of information, including the patient name, patient identifier (e.g. MRN), exam type, and exam identifier (e.g., accession #). At step 320, the information from step 310 is displayed. The display is in a table, where the fields of the entries are partially populated. At step 330 other demographic information (e.g., patient date of birth, age, gender, etc.) is collected. The information from steps 330 and 310 are integrated, and then displayed at step 350. The flow chart then loops back to step 330, where additional information (e.g., performing resource, exam subspecialty, who performed the exam, etc.) is collected, integrated, and then displayed at steps 340 and 350. Looping back to step 330, image status information is collected. The image status information is integrated with the previous portions of information, and displayed in steps 340 and 350. Again, looping back to step 330 and then flowing through steps 340 and 350, information relating to the patient(s)' past exams is collected, integrated and collected.

As another illustration, at step 310, for each stat exam, all possible information is collected based on a query to a SQL database. Further at step 310, only patient demographics are collected for non-stat exams, again through a query to the SQL database. The information is pipelined for step 320, such that the collected information for the stat exams is displayed, while no information for non-stat exams is displayed. At step 330, the pipelined information for non-stat exams is collected, and integrated with the stat exam information at step 340, and displayed at step 350. Looping back to step 330, the remaining exam information is collected from the database, integrated with previously collected data at step 340, and then displayed at step 350. The flow chart then iterates steps 330-350 for n phases. During this iteration, image status information for the remaining n exams is collected, integrated, and then displayed incrementally. The flow chart then iterates steps 330-350 for each exam. The subsequent collections of information result from thumbnail image generation relating to each of the patients' current study. The thumbnail is then collected, integrated and displayed. The loop iterates until all thumbnails have been displayed in the table.

Thus, embodiments of the present invention provide for efficiently displaying clinical information to a user. While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. For example, features may be implemented with software, hardware, or a mix thereof. Therefore, it is intended that the invention not be limited to the particular embodiment disclosed, but that the invention will include all embodiments falling within the scope of the appended claims.

1. A system for dynamically displaying clinical information to a user, the system comprising:
a table for displaying the clinical information, said table comprising entries;
an information display subsystem for displaying the clinical information in said table; and
an information collection subsystem for collecting a first portion of the clinical information at a first time, for collecting a second portion of the clinical information at a second time, and for providing said first and second portions to said information display subsystem,
wherein said information display subsystem displays said first portion of the clinical information at a first display time in said table, and integrates said first and second portions of the clinical information to form an integrated data set, and displays said integrated data set in said table at a second display time such that each of at least a portion of said entries comprises information from both of said first and second portions of the clinical information.

2. The system of claim 1, wherein said first and second portions of the clinical information are determined by at least one of: a domain specific set of rules, and a user specific set of rules.

3. The system of claim 1, wherein said information collection subsystem further pipelines said first and second portions of information to information display subsystem.

4. The system of claim 1, wherein the user is capable of interacting with an entry at substantially said first display time.

5. The system of claim 1 further comprising an intelligent learning subsystem for adjusting the dynamic display of clinical information to the user in said table.

6. The system of claim 1, wherein said first portion of the clinical information results from a query to a relational database, and said second portion of the clinical information results from a sub-query to said relational database.

7. The system of claim 1, wherein said second portion of the clinical information results from calculations performed on at least a portion of said first portion of the clinical information.

8. A method for dynamically displaying clinical information to a user, said method comprising:
receiving at a first collection time a first portion of the clinical information;
displaying at a first display time said first portion of the clinical information in a table comprising entries;
receiving at a second collection time a second portion of the clinical information;
integrating said first and second portions of the clinical information to form an integrated data set for display in said entries, such that at least a portion of said entries comprises information from both said first and second portions of clinical information; and
displaying at a second display time said integrated data set.

9. The method of claim 8, wherein said first and second portions of the clinical information are determined by at least one of: a domain specific set of rules, and a user specific set of rules.

10. The method of claim 8 further comprising pipelining each of said first and second portions of the clinical information.

11. The method of claim 8, wherein the user is capable of interacting with an entry at substantially said first display time.

12. The method of claim 8 further comprising intelligently learning interactions of a user to adjust the dynamic display of clinical information to the user in said table.

13. The method of claim 8, wherein said first portion of the clinical information results from a query to a relational database, and said second portion of the clinical information results from a sub-query to said relational database.

14. The method of claim 8, wherein said second portion of the clinical information results from calculations performed on at least a portion of said first portion of the clinical information.

15. A computer readable storage medium including a set of instructions for a computer, the set of instructions comprising:
a reception routine for receiving at a first collection time a first portion of clinical information, and for receiving at a second collection time a second portion of said clinical information;
an integration routine for integrating said first and second portions of clinical information to form an integrated data set for display in a table having entries, such that at least a portion of said entries includes information from both of said first and second portions of clinical information; and
a display routine for displaying at a first display time said first portion of clinical information in said table, and for displaying a second display time said integrated data set in said table.

16. The set of instructions of claim 15, wherein said first and second portions of the clinical information are determined by at least one of: a domain specific set of rules, and a user specific set of rules.

17. The set of instructions of claim 15, wherein at least a portion of said entries comprises information from said first portion of the clinical information only.

18. The set of instructions of claim 15 further comprising a learning routine for intelligently learning a users interactions with said table to subsequently adjust a dynamic display of clinical information.

19. The set of instructions of claim 15, wherein said first portion of the clinical information results from a query to a relational database, and said second portion of the clinical information results from a sub-query to said relational database.

20. The set of instructions of claim 15, wherein said second portion of the clinical information results from calculations performed on at least a portion of said first portion of the clinical information.
